(19) United States
(12) Patent Application Publication
(10) Pub. No.: US 2009/0214136 A1
(43) Pub. Date: Aug. 27, 2009

(54) IMAGE PROCESSING APPARATUS FOR SCALING AN INPUT IMAGE ACCORDING TO VARIOUS IMAGE PROCESSING REQUIREMENTS AND METHOD THEREOF

(76) Inventors: Chia-Yun Cheng, Hsinchu City (TW); Chi-Cheng Ju, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/035,446

(22) Filed: Feb. 22, 2008

(51) Int. Cl. G06K 9/32

(52) U.S. Cl. 382/298

(57) ABSTRACT

An image processing apparatus and method for scaling an input image are disclosed. The image processing apparatus includes a buffer module, a scaling unit, and a determining unit. The buffer module includes at least a line buffer for buffering pixel data of the input image. The scaling unit is coupled to the buffer module and includes a plurality of filters having different filter tap numbers, wherein the scaling unit utilizes a target filter having a specific filter tap number selected from the plurality of filters to scale the input image according to the pixel data retrieved from the line buffer. The determining unit is coupled to the scaling unit and utilized for receiving an image processing requirement and setting a pixel precision of the input image and selecting the target filter having the specific filter tap number from the filters in the scaling unit according to the image processing requirement.

### BACKGROUND

The present invention relates to an image processing apparatus and method, and more particularly, to an image processing apparatus for scaling an input image according to various image processing requirements and method thereof.

Display apparatuses such as televisions, LCD monitors, plasma monitors, and projectors, etc. can be utilized for displaying static images or dynamic video. Different video formats usually have different resolutions: for example, a Video Graphics Array (VGA) format has a resolution of 640*480, while Super Extended Graphics Array (SXGA) is 1280*1024. If the resolution of the display apparatus is different from the resolution of the input image, the input image must first be scaled in order to display the input image correctly.

In the conventional arts, there are two familiar image-processing methods for scaling an input image. The first image processing method uses a frame buffer to register the input image frame, and the second image processing method uses a line buffer to register a portion of the input image's scan lines. The image processing method using the frame buffer requires higher hardware cost than the image processing method using the line buffer, and therefore the line buffer is often adapted as the preferred choice.

In addition, 2-Dimensional (2D) image scaling is performed since there are two dimensions in an image. In general, one dimension of the input image is scaled and stored into the temporary buffer and the other dimension of the input image is scaled and output the result. In practical hardware design, the line buffers are used instead of the temporary buffer. Thus, the line buffer could be used for storing not only the input image data but also the temporary data.

In the conventional image processing method mentioned above, a scaling unit that includes a filter having a fixed number of filter taps is utilized to perform the scaling operation on the input image in order to attain the image scaling effects. In addition, a pixel precision of the input image is not adjustable in the conventional image processing method. There are, however, more and more image processing requirements such as various image quality requirements, different image scaling ratio requirements, different image processing rate (i.e. image processing throughput) requirements, various image output devices, etc. This means different scaling algorithms are required, and it is obvious that the conventional image processing methods and the related image processing apparatuses are not fully capable of scaling the input image according to the various image processing requirements mentioned above.

### SUMMARY OF THE INVENTION

It is therefore one of the objectives of the present invention to provide an image processing apparatus for scaling an input image according to various image processing requirements and method thereof, to solve the above problem.

According to an exemplary embodiment of the present invention, an image processing apparatus for scaling an input image is disclosed. The image processing apparatus includes a determining unit, a buffer module, and a scaling unit. The buffer module includes at least a line buffer for buffering pixel data of the input image, wherein the buffered pixel data could be the original pixel data of input image or the scaled pixel data of input image. The determining unit is utilized for receiving an image processing requirement and setting a pixel precision of the input image according to the image processing requirement. The buffer module is coupled to the determining unit and includes at least a line buffer for buffering pixel data of the input image. The scaling unit is coupled to the buffer module and utilized for scaling the input image according to the pixel data retrieved from the at least a line buffer.

According to an exemplary embodiment of the present invention, an image processing apparatus for scaling an input image is further disclosed. The image processing apparatus includes a buffer module, a scaling unit, and a determining unit. The buffer module includes at least a line buffer for buffering pixel data of the input image. The scaling unit is coupled to the buffer module and includes a plurality of filters having different filter tap numbers, wherein the scaling unit utilizes a target filter having a specific filter tap number selected from the plurality of filters to scale the input image according to the pixel data retrieved from the at least a line buffer. The determining unit is coupled to the scaling unit and utilized for receiving an image processing requirement and selecting the target filter having the specific filter tap number from the plurality of filters in the scaling unit according to the image processing requirement.

According to an exemplary embodiment of the present invention, an image processing method for scaling an input image is yet further disclosed. The image processing method includes: receiving an image processing requirement; setting a pixel precision of the input image according to the image processing requirement; buffering pixel data of the input image; and scaling the input image according to the pixel data.

According to an exemplary embodiment of the present invention, an image processing method for scaling an input image is yet further disclosed. The image processing method includes: receiving an image processing requirement; selecting a target filter having a specific filter tap number from a plurality of filters in a scaling unit according to the image processing requirement; buffering pixel data of the input image; and scaling the input image according to the pixel data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of an image processing apparatus for scaling an input image according to various image processing requirements according to a first embodiment of the present invention.

FIG. 2 is a flowchart showing an exemplary method for image processing method for scaling the input image according to the first embodiment of the present invention.

FIG. 3 shows a simplified block diagram of an image processing apparatus for scaling an input image according to various image processing requirements according to a second embodiment of the present invention.

FIG. 4 is a flowchart showing an exemplary method for image processing method for scaling the input image according to the second embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . . ” The terms “couple” and “coupled” are intended to mean either an indirect or a direct electrical connection. Thus, if a first device couples to a second device, that connection may be through a direct electrical connection, or through an indirect electrical connection via other devices and connections.

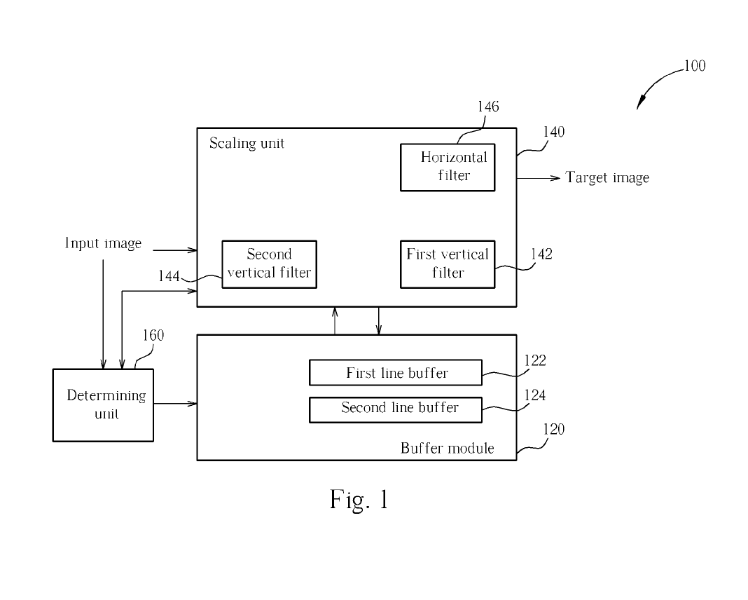

Please refer to FIG. 1. FIG. 1 shows a simplified block diagram of an image processing apparatus 100 for scaling an input image according to various image processing requirements according to a first embodiment of the present invention. The image processing apparatus 100 includes a buffer module 120, a scaling unit 140, and a determining unit 160, wherein the buffer module 120 can include at least a line buffer for buffering the input image pixel data. In the first embodiment, the buffer module 120 includes a first line buffer 122 and a second line buffer 124 for buffering the pixel data of the input image. Please note that this is only for an illustration purpose and is not meant as a limitation of the present invention.

The scaling unit 140 is coupled to the buffer module 120 and utilized for scaling the input image according to the pixel data retrieved from the first line buffer 122 and the second line buffer 124. The determining unit 160 is coupled to the scaling unit 140 and utilized for receiving some image processing requirements such as various image quality requirements, different image scaling ratio requirements, different image processing rate (i.e. image processing throughput) requirements, and various image output devices. Then, the determining unit 160 will be utilized for setting a pixel precision of the input image according to the different image processing requirements. In addition, the scaling unit 140 can include a plurality of filters having different filter tap numbers, and the determining unit 160 can be utilized for selecting a target filter having a specific filter tap number from the plurality of filters according to the different image processing requirements. Then, the scaling unit can scale the input image by the target filter having the specific filter tap number. For example, the scaling unit 140 includes a first vertical filter 142 having 2 filter taps, a second vertical filter 144 having 4 filter taps, and a horizontal filter 146 in the first embodiment. The determining unit 160 is utilized for selecting a target vertical filter from the first vertical filter 142 and the second vertical filter 144, and then the scaling unit can scale the input image by the target vertical filter. Please note that this example is only for illustrative purposes and is not meant as a limitation of the present invention.

Suppose that both the first line buffer 122 and the second line buffer 124 have an M-bit input, an M-bit output, and a predetermined line buffer length L, and that the input image has a pixel precision (i.e. bits per pixel) R, and the target vertical filter has a vertical filter tap number S. From this, a processing pixel number per pass N will be equal to 2ML/RS. For example, if M=16, L=360, R=8, and S=4, then N=360.

In a first case of the first embodiment, when the image processing requirement corresponds to a first image scaling ratio smaller than a predetermined number, which could be set as 1 for illustration purpose, a product of the specific filter tap number and the pixel precision of the input image set by the determining unit 160 will be equal to a first value; when the image processing requirement corresponds to a second image scaling ratio greater than 1, a product of the specific filter tap number and the pixel precision of the input image set by the determining unit 160 will be equal to a second value which is smaller than the first value. For example, if the height of an input image is far greater than the height of a target image (i.e. an image scaling ratio between the target image height and the source image height is far smaller than 1), an integrating algorithm is more appropriate to be utilized. The integrating algorithm is well known to be realized as taking advantage on integral method for calculating coefficient of filter taps or purpose of finding the weighting function, and is sometimes so called as Multi-taps filtering process. For brevity, the detail of integrating algorithm is omitted here and it should be applied to all methods up to the point that one who has relevant knowledge in the art understand of the integrating algorithm. The image processing method of the present invention will utilize the determining unit 160 to select the first vertical filter 142 having 2 filter taps and set the pixel precision R of the input image to be 16. Then the processing pixel number per pass N will be equal to 360. On the other hand, if the input image height is far smaller than the target image height (i.e. an image scaling ratio between the target image height and the source image height is far greater than 1), then the image processing method of the present invention will utilize the determining unit 160 to select the first vertical filter 142 having 2 filter taps and set the pixel precision R of the input image to be 8, and then the processing pixel number per pass N will be equal to 720. Please note that this is only for illustrative purposes and is not meant as a limitation of the present invention.

In a second case of the first embodiment, when the image processing requirement corresponds to a first image quality requirement, a product of the specific filter tap number and the pixel precision of the input image set by the determining unit will be equal to a first value; when the image processing requirement corresponds to a second image quality requirement that is lower than the first image quality requirement, a product of the specific filter tap number and the pixel precision of the input image set by the determining unit will be equal to a second value smaller than the first value. For example, if the determining unit 160 receives a higher image quality requirement, then the image processing method of the present invention will utilize the determining unit 160 to select the second vertical filter 144 having 4 filter taps and set the pixel precision R of the input image to be 16, and then the processing pixel number per pass N will be equal to 180. On the other hand, if the determining unit 160 receives a lower image quality requirement, then the image processing method of the present invention will utilize the determining unit 160 to select the first vertical filter 142 having 2 filter taps and set the pixel precision R of the input image to be 8, and the processing pixel number per pass N will be equal to 720. Please note that this is only for illustrative purposes and is not meant as a limitation of the present invention.

In a third case of the first embodiment, when the image processing requirement corresponds to a first image processing throughput, a product of the specific filter tap number and the pixel precision of the input image set by the determining unit will be equal to a first value, and when the image processing requirement corresponds to a second image processing throughput which is greater than the first image processing throughput, a product of the specific filter tap number and the pixel precision of the input image set by the determining unit will be equal to a second value smaller than the first value. For example, if the determining unit 160 receives the image processing requirement corresponding to a smaller image processing throughput, then the image processing method of the present invention will utilize the determining unit 160 to select the second vertical filter 144 having 4 filter taps and set the pixel precision R of the input image to be 8, and then the processing pixel number per pass N will be equal to 360. On the other hand, if the determining unit 160 receives the image processing requirement corresponding to a greater image processing throughput, then the image processing method of the present invention will utilize the determining unit 160 to select the first vertical filter 142 having 2 filter taps and set the pixel precision R of the input image to be 4, and then the processing pixel number per pass N will be equal to 1440. Please note that this is only for illustrative purposes and is not meant as a limitation of the present invention.

In a fourth case of the first embodiment, if the image processing requirements corresponds to various image output devices such as an HDMI (high-definition multimedia interface) device that has an adjustable output pixel precision, then the pixel precision of the input image can be set by the determining unit 160 so as to fit in with the requirements of the various image output devices. Please note that this is only for illustrative purposes and is not meant as a limitation of the present invention.

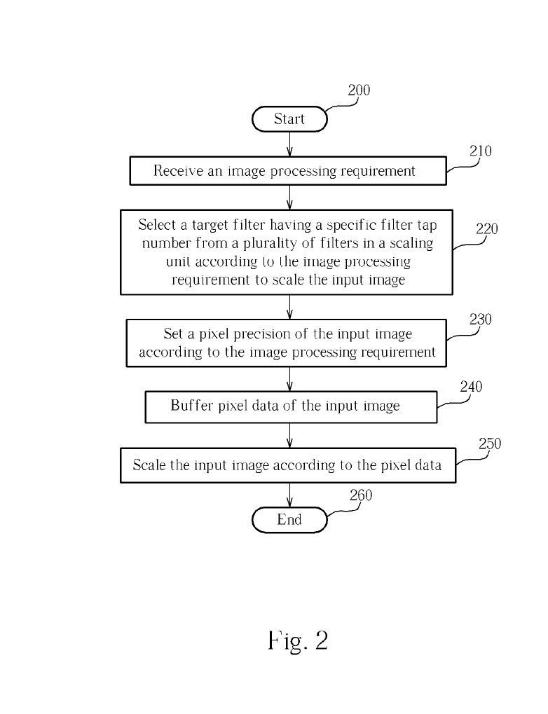

To summarize the above operations concisely, please refer to FIG. 2. FIG. 2 is a flowchart showing an exemplary method for an image processing method for scaling the input image according to the first embodiment of the present invention. Provided that substantially the same result is achieved, the steps of the process flowchart need not be in the exact order shown and need not be contiguous; that is, other steps can be intermediate. The image processing flow includes the following steps:
Step 200: Start.
Step 210: Receive an image processing requirement.
Step 220: Select a target filter having a specific filter tap number from a plurality of filters in a scaling unit according to the image processing requirement to scale the input image.
Step 230: Set a pixel precision of the input image according to the image processing requirement.
Step 240: Buffer pixel data of the input image.
Step 250: Scale the input image according to the pixel data.
Step 260: End.

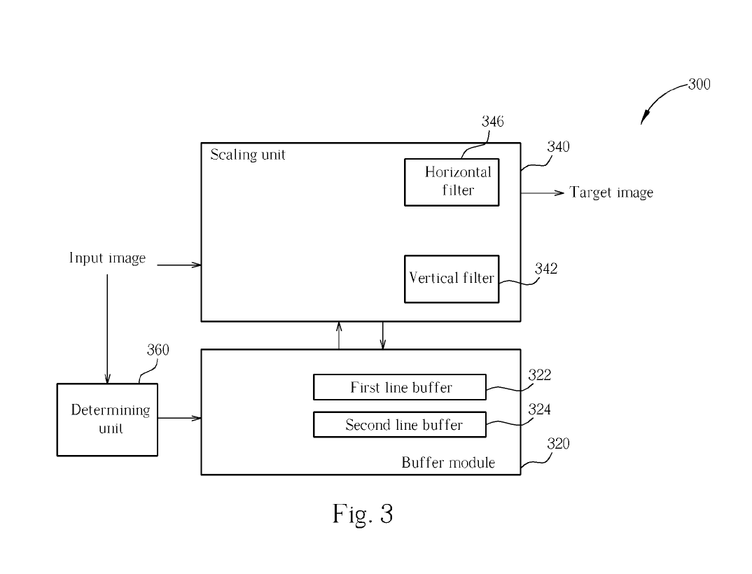

Please refer to FIG. 3. FIG. 3 shows a simplified block diagram of an image processing apparatus 300 for scaling an input image according to various image processing requirements according to a second embodiment of the present invention. The image processing apparatus 300 includes a buffer module 320, a scaling unit 340, and a determining unit 360, wherein the buffer module 320 can include at least a line buffer for buffering pixel data of the input image. In the second embodiment, the buffer module 320 includes a first line buffer 322 and a second line buffer 324 for buffering the pixel data of the input image. Please note that this is only for illustrative purposes and is not meant as a limitation of the present invention.

The scaling unit 340 is coupled to the buffer module 320 and utilized for scaling the input image according to the pixel data retrieved from the first line buffer 322 and the second line buffer 324. The determining unit 360 is coupled to the scaling unit 340 and utilized for receiving some image processing requirements such as various image quality requirements, different image scaling ratio requirements, different image processing rate requirements, and various image output devices, and for setting a pixel precision of the input image according to the different image processing requirements. In addition, in the second embodiment, the scaling unit 340 includes a vertical filter 342 having 2 filter taps, and a horizontal filter 346. Please note that this is only for illustrative purposes and is not meant as a limitation of the present invention.

Similar to the first embodiment, suppose that both the first line buffer 322 and the second line buffer 324 have an M-bit input, an M-bit output, a predetermined line buffer length L, the input image has a pixel precision (i.e. bits per pixel) R, and the vertical filter has a vertical filter tap number S. Then a processing pixel number per pass N will be equal to 2ML/RS; for example, if M=16, L=360, R=8, S=2, then N=720.

In a first case of the second embodiment, when the image processing requirement corresponds to a first image scaling ratio smaller than a predetermined number, which could be set as 1 for illustration purpose, the pixel precision of the input image set by the determining unit 360 is equal to a first value, and when the image processing requirement corresponds to a second image scaling ratio greater than 1, the pixel precision of the input image set by the determining unit 360 will be equal to a second value smaller than the first value. For example, if the input image height is far greater than the target image height (i.e. an image scaling ratio between the target image height and the source image height is far smaller than 1), an integrating algorithm is more appropriate to be utilized. The image processing method of the present invention will utilize the determining unit 360 to set the pixel precision R of the input image to be 16, and then the processing pixel number per pass N will be equal to 360. On the other hand, if the input image height is far smaller than the target image height (i.e. an image scaling ratio between the target image height and the source image height is far greater than 1), then the image processing method of the present invention will utilize the determining unit 360 to set the pixel precision R of the input image to be 8, and then the processing pixel number per pass N will be equal to 720. Please note that this is only for illustrative purposes and is not meant as a limitation of the present invention.

In a second case of the second embodiment, when the image processing requirement corresponds to a first image quality requirement, the pixel precision of the input image set by the determining unit will be equal to a first value, and when the image processing requirement corresponds to a second image quality requirement lower than the first image quality requirement, the pixel precision of the input image set by the determining unit will be equal to a second value smaller than the first value. For example, if the determining unit 360 receives a higher image quality requirement, then the image processing method of the present invention will utilize the determining unit 360 to set the pixel precision R of the input image to be 32, and then the processing pixel number per pass N will be equal to 180. On the other hand, if the determining unit 360 receives a lower image quality requirement, then the image processing method of the present invention will utilize the determining unit 360 to set the pixel precision R of the input image to be 8, and then the processing pixel number per pass N will be equal to 720. Please note that this is only for illustrative purposes and is not meant as a limitation of the present invention.

In a third case of the second embodiment, when the image processing requirement corresponds to a first image processing throughput, the pixel precision of the input image set by the determining unit is equal to a first value; when the image processing requirement corresponds to a second image processing throughput greater than the first image processing throughput, the pixel precision of the input image set by the determining unit will be equal to a second value smaller than the first value. For example, if the determining unit 360 receives the image processing requirement corresponding to a smaller image processing throughput, then the image processing method of the present invention will utilize the determining unit 360 to set the pixel precision R of the input image to be 16, and then the processing pixel number per pass N will be equal to 360. On the other hand, if the determining unit 360 receives the image processing requirement corresponds to a greater image processing throughput, then the image processing method of the present invention will utilize the determining unit 360 to set the pixel precision R of the input image to be 4, and then the processing pixel number per pass N will be equal to 1440. Please note that this is only for illustrative purposes and is not meant as a limitation of the present invention.

In a fourth case of the second embodiment, if the image processing requirements corresponds to various image output devices such as an HDMI (high-definition multimedia interface) device that has an adjustable output pixel precision, then the pixel precision of the input image can be set by the determining unit 360 so as to fit in with the requirements of the various image output devices. Please note that this is only for illustrative purposes and is not meant as a limitation of the present invention.

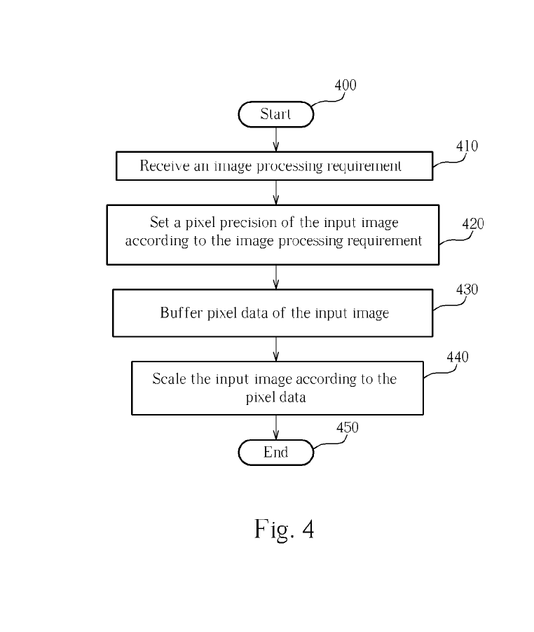

To summarize the above operations concisely, please refer to FIG. 4. FIG. 4 is a flowchart showing an exemplary method for image processing method for scaling the input image according to the second embodiment of the present invention. Provided that substantially the same result is achieved, the steps of the process flowchart need not be in the exact order shown and need not be contiguous; that is, other steps can be intermediate. The image processing flow includes the following steps:
Step 400: Start.
Step 410: Receive an image processing requirement.
Step 420: Set a pixel precision of the input image according to the image processing requirement.
Step 430: Buffer pixel data of the input image.
Step 440: Scale the input image according to the pixel data.
Step 450: End.

Briefly summarized, since the present invention can set a pixel precision of the input image according to the various image processing requirements such as various image quality requirements, different image scaling ratio requirements, different image processing rate (i.e. image processing throughput) requirements, and various image output devices, the present invention is capable of scaling the input image according to the various image processing requirements mentioned above. In addition, the image processing apparatus of the present invention can include a scaling unit having a plurality of filters having different filter tap numbers, and a determining unit for receiving the various image processing requirements and selecting a target filter having a specific filter tap number from the plurality of filters in the scaling unit according to the various image processing requirements, so as to scale the input image according to the pixel data retrieved from at least a line buffer of a buffer module. Therefore, the present invention offers an efficient and economical solution for scaling the input image according to the various image processing requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing apparatus for scaling an input image, the image processing apparatus comprising:
a determining unit, for receiving an image processing requirement and setting a pixel precision of the input image according to the image processing requirement;
a buffer module, coupled to the determining unit, comprising at least a line buffer for buffering pixel data of the input image; and
a scaling unit, coupled to the buffer module, for scaling the input image according to the pixel data retrieved from the at least a line buffer.

2. The image processing apparatus of claim 1, wherein the scaling unit further comprises a plurality of filters having different filter tap numbers; and the determining unit is coupled to the scaling unit for selecting a target filter having a specific filter tap number from the plurality of filters according to the image processing requirement; and the scaling unit scales the input image by the target filter.

3. The image processing apparatus of claim 2, wherein the plurality of filters are vertical filters.

4. The image processing apparatus of claim 2, wherein when the image processing requirement corresponds to a first image scaling ratio smaller than a predetermined number, a product of the specific filter tap number and the pixel precision of the input image set by the determining unit is equal to a first value, and when the image processing requirement corresponds to a second image scaling ratio greater than the predetermined number, a product of the specific filter tap number and the pixel precision of the input image set by the determining unit is equal to a second value smaller than the first value.

5. The image processing apparatus of claim 2, wherein when the image processing requirement corresponds to a first image quality requirement, a product of the specific filter tap number and the pixel precision of the input image set by the determining unit is equal to a first value, and when the image processing requirement corresponds to a second image quality requirement lower than the first image quality requirement, a product of the specific filter tap number and the pixel precision of the input image set by the determining unit is equal to a second value smaller than the first value.

6. The image processing apparatus of claim 2, wherein when the image processing requirement corresponds to a first image processing throughput, a product of the specific filter tap number and the pixel precision of the input image set by the determining unit is equal to a first value, and when the image processing requirement corresponds to a second image processing throughput greater than the first image processing throughput, a product of the specific filter tap number and the pixel precision of the input image set by the determining unit is equal to a second value smaller than the first value.

7. The image processing apparatus of claim 1, wherein when the image processing requirement corresponds to a first image scaling ratio smaller than a predetermined number, the pixel precision of the input image set by the determining unit is equal to a first value, and when the image processing requirement corresponds to a second image scaling ratio greater than the predetermined number, the pixel precision of the input image set by the determining unit is equal to a second value smaller than the first value.

8. The image processing apparatus of claim 1, wherein when the image processing requirement corresponds to a first image quality requirement, the pixel precision of the input image set by the determining unit is equal to a first value, and when the image processing requirement corresponds to a second image quality requirement lower than the first image quality requirement, the pixel precision of the input image set by the determining unit is equal to a second value smaller than the first value.

9. The image processing apparatus of claim 1, wherein when the image processing requirement corresponds to a first image processing throughput, the pixel precision of the input image set by the determining unit is equal to a first value, and when the image processing requirement corresponds to a second image processing throughput greater than the first image processing throughput, the pixel precision of the input image set by the determining unit is equal to a second value smaller than the first value.

10. An image processing apparatus for scaling an input image, the image processing apparatus comprising:
a buffer module, comprising at least a line buffer for buffering pixel data of the input image;
a scaling unit, coupled to the buffer module, comprising a plurality of filters having different filter tap numbers, wherein the scaling unit utilizes a target filter having a specific filter tap number selected from the plurality of filters to scale the input image according to the pixel data retrieved from the at least a line buffer; and
a determining unit, coupled to the scaling unit, for receiving an image processing requirement and selecting the target filter having the specific filter tap number from the plurality of filters in the scaling unit according to the image processing requirement.

11. The image processing apparatus of claim 10, wherein when the image processing requirement corresponds to a first image scaling ratio smaller than a predetermined number, the specific filter tap number of the target filter selected by the determining unit is equal to a first value, and when the image processing requirement corresponds to a second image scaling ratio greater than the predetermined number, the specific filter tap number of the target filter selected by the determining unit is equal to a second value smaller than the first value.

12. The image processing apparatus of claim 10, wherein when the image processing requirement corresponds to first image quality requirement, the specific filter tap number of the target filter selected by the determining unit is equal to a first value, and when the image processing requirement corresponds to a second image quality requirement lower than the first image quality requirement, the specific filter tap number of the target filter selected by the determining unit is equal to a second value smaller than the first value.

13. The image processing apparatus of claim 10, wherein when the image processing requirement corresponds to a first image processing throughput, the specific filter tap number of the target filter selected by the determining unit is equal to a first value, and when the image processing requirement corresponds to a second image processing throughput greater than the first image processing throughput, the specific filter tap number of the target filter selected by the determining unit is equal to a second value smaller than the first value.

14. An image processing method for scaling an input image, the image processing method comprising:
receiving an image processing requirement;
setting a pixel precision of the input image according to the image processing requirement;
buffering pixel data of the input image; and
scaling the input image according to the pixel data.

15. The image processing method of claim 14, further comprising:
selecting a target filter having a specific filter tap number from a plurality of filters in a scaling unit according to the image processing requirement to scale the input image.

16. The image processing method of claim 15, wherein when the image processing requirement corresponds to a first image scaling ratio smaller than a predetermined number, a product of the specific filter tap number and the pixel precision is equal to a first value, and when the image processing requirement corresponds to a second image scaling ratio greater than the predetermined number, a product of the specific filter tap number and the pixel precision is equal to a second value smaller than the first value.

17. The image processing method of claim 15, wherein when the image processing requirement corresponds to a first image quality requirement, a product of the specific filter tap number and the pixel precision is equal to a first value, and when the image processing requirement corresponds to a second image quality requirement lower than the first image quality requirement, a product of the specific filter tap number and the pixel precision is equal to a second value smaller than the first value.

18. The image processing method of claim 15, wherein when the image processing requirement corresponds to a first image processing throughput, a product of the specific filter tap number and the pixel precision is equal to a first value, and when the image processing requirement corresponds to a second image processing throughput greater than the first image processing throughput, a product of the specific filter tap number and the pixel precision is equal to a second value smaller than the first value.

19. The image processing method of claim 14, wherein when the image processing requirement corresponds to a first image scaling ratio smaller than a predetermined number, the pixel precision is equal to a first value, and when the image processing requirement corresponds to a second image scaling ratio greater than the predetermined number, the pixel precision is equal to a second value smaller than the first value.

20. The image processing method of claim 14, wherein when the image processing requirement corresponds to a first image quality requirement, the pixel precision is equal to a first value, and when the image processing requirement corresponds to a second image quality requirement lower than the first image quality requirement, the pixel precision is equal to a second value smaller than the first value.

21. The image processing method of claim 14, wherein when the image processing requirement corresponds to a first image processing throughput, the pixel precision is equal to a first value, and when the image processing requirement corresponds to a second image processing throughput greater than the first image processing throughput, the pixel precision is equal to a second value smaller than the first value.

22. An image processing method for scaling an input image, the image processing method comprising:
receiving an image processing requirement;
selecting a target filter having a specific filter tap number from a plurality of filters in a scaling unit according to the image processing requirement;
buffering pixel data of the input image; and
scaling the input image according to the pixel data.

23. The image processing method of claim 22, wherein when the image processing requirement corresponds to a first image scaling ratio smaller than a predetermined number, the specific filter tap number of the selected target filter is equal to a first value, and when the image processing requirement corresponds to a second image scaling ratio greater than the predetermined number, the specific filter tap number of the selected target filter is equal to a second value smaller than the first value.

24. The image processing method of claim 22, wherein when the image processing requirement corresponds to a first image quality requirement, the specific filter tap number of the selected target filter is equal to a first value, and when the image processing requirement corresponds to a second image quality requirement lower than the first image quality requirement, the specific filter tap number of the selected target filter is equal to a second value smaller than the first value.

25. The image processing method of claim 22, wherein when the image processing requirement corresponds to a first image processing throughput, the specific filter tap number of the selected target filter is equal to a first value, and when the image processing requirement corresponds to a second image processing throughput greater than the first image processing throughput, the specific filter tap number of the selected target filter is equal to a second value smaller than the first value.
